(19) United States
(12) Patent Application Publication
(10) Pub. No.: US 2022/0360712 A1
(43) Pub. Date: Nov. 10, 2022

(54) CAMERA MODULE AND IMAGING DEVICE INCLUDING THE SAME

(71) Applicant: SAMSUNG ELECTRONICS CO., LTD., Suwon-si (KR)

(72) Inventors: Jongwoo KIM, Suwon-si (KR); Kilwoo CHUNG, Seongnam-si (KR); Daeyoung KIM, Hwaseong-si (KR); Suyoung LEE, Daejeon (KR)

(21) Appl. No.: 17/702,360

(22) Filed: Mar. 23, 2022

(30) Foreign Application Priority Data
May 10, 2021 (KR) 10-2021-0060329

(51) Int. Cl. H04N 5/232

(52) U.S. Cl. CPC H04N 5/23287; H04N 5/23267; H04N 5/23296

(57) ABSTRACT

An imaging device includes a lens module configured to receive an optical signal, an image sensor configured to generate image data based on the received optical signal, a tilting module configured to adjust a position of the image sensor, and a processor configured to control the tilting module based on the image data. The processor is further configured to recognize a target object from the image data and control the tilting module in response to comparing a location of the target object with reference location information including object location information.

### CROSS-REFERENCE TO RELATED APPLICATION

This application is based on and claims priority under 35 U.S.C. § 119 to Korean Patent Application No. 10-2021-0060329, filed on May 10, 2021, in the Korean Intellectual Property Office, the disclosure of which is incorporated by reference herein in its entirety.

### BACKGROUND

The inventive concept relates to a camera module and an imaging device including the camera module.

Recently, due to the expansion of camera functions of electronic devices such as smartphones, a plurality of camera modules, each including an image sensor, are being provided in smartphones. These camera modules may employ image stabilization (IS) technology to correct or prevent image shake due to camera movement caused by an unstable fixing device or a user's movement.

IS technology may include optical image stabilizer (OIS) which involves a method of correcting image quality by moving a lens or image sensor of a camera to correct the optical path. In particular, camera movement, such as caused by shaking of a hand of a user, is detected through a gyro sensor, a distance a lens or image sensor needs to move is calculated based on the detected camera movement, and the effects caused by the camera movement are overcome using a lens movement method or a module tilting method.

### SUMMARY

The inventive concept provides a camera module for capturing an optimal scene by using a tilting device, and an imaging device including the camera module.

According to an aspect of the inventive concept, there is provided an imaging device including a lens module configured to receive an optical signal, an image sensor configured to generate image data based on the received optical signal, a tilting module configured to adjust a position of the image sensor, and a processor configured to control the tilting module based on the image data. The processor is further configured to recognize a target object from the image data and control the tilting module in response to comparing a location of the target object with reference location information including object location information.

According to another aspect of the inventive concept, there is provided an electronic device including a camera module configured to provide a selfie photograph assistance function, and a processor. The camera module includes a lens module configured to receive an optical signal, an image sensor configured to generate image data based on the received optical signal, a tilting module configured to adjust a position of the camera module, and an interface circuit configured to communicate with the processor, transmit the image data to the processor, and receive tilting control data for controlling the tilting module from the processor. The processor is configured to recognize a target object from the image data, compare a location of the target object with reference location information including object location information when capturing an image and generate the tilting control data, and transmit the tilting control data to the tilting module through the interface circuit.

According to another aspect of the inventive concept, there is provided a method of controlling a camera module supporting selfie photograph assistance, the method including: generating image data based on an optical signal received through the camera module, recognizing a target object based on the generated image data, and generating target object information; comparing the target object information with reference location information including object location information when capturing an image; and controlling a field of view for photographing by adjusting a position of the camera module in response to comparing the target object information with the reference location information.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an imaging device according to an example embodiment of the inventive concept;

FIG. 2 is a block diagram of an imaging device according to an example embodiment of the inventive concept;

FIG. 3 is a diagram illustrating a field of view of an imaging device according to an example embodiment of the inventive concept;

FIGS. 4A and 4B are diagrams illustrating a field of view of an imaging device according to an example embodiment of the inventive concept;

FIGS. 5A to 5C are diagrams illustrating a tilting operation of an imaging device according to an example embodiment of the inventive concept;

FIGS. 6A to 6D are diagrams illustrating a tilting algorithm of an imaging device according to an example embodiment of the inventive concept;

FIGS. 7A to 7C are diagrams illustrating a tilting algorithm of an imaging device according to an example embodiment of the inventive concept;

FIGS. 8A and 8B are diagrams illustrating panoramic photographing by an imaging device according to an example embodiment of the inventive concept;

FIG. 9 is a flowchart illustrating an operation of an imaging device according to an example embodiment of the inventive concept;

FIG. 10A is an exploded perspective view of an image sensor according to an example embodiment, and FIG. 10B is a plan view of the image sensor;

FIG. 11 is a block diagram of an electronic device including a multi-camera module, according to an example embodiment; and

FIG. 12 is a detailed block diagram of a camera module in the electronic device of FIG. 11.

### DETAILED DESCRIPTION OF THE EMBODIMENTS

Hereinafter, embodiments of the inventive concept will be described in detail with reference to the accompanying drawings.

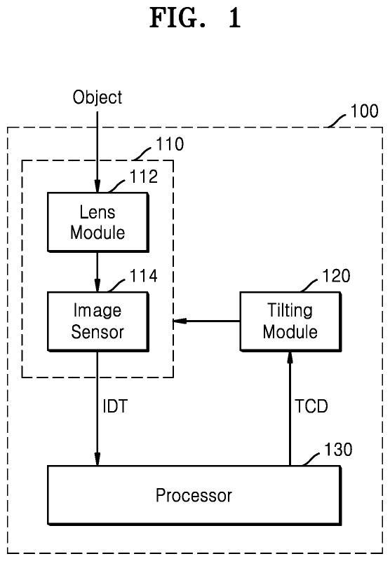

FIG. 1 is a block diagram of an imaging device according to an example embodiment of the inventive concept.

An imaging device 100 according to an example embodiment of the inventive concept may be provided in an electronic device having an image capturing or light sensing function. For example, the imaging device 100 may be provided in an electronic device such as a digital still camera, a digital video camera, a smartphone, a wearable device, an Internet of Things (IoT) device, a tablet personal computer (PC), a personal digital assistant (PDA), a portable multimedia player (PMP), and a navigation device. Also, the imaging device 100 may be provided in an electronic device provided as a component in a vehicle, furniture, a manufacturing facility, a door, and various measurement devices.

Referring to FIG. 1, the imaging device 100 may include a lens module 112, an image sensor 114, a tilting module 120, and a processor 130. For example, the lens module 112 and the image sensor 114 may be included in a camera module 110.

The lens module 112 may include a lens. The lens may receive light reflected by an object located within a viewing angle. According to an embodiment, the lens module 112 may be arranged to face a specified direction (e.g., a front or rear direction of the imaging device 100). According to an embodiment, the lens module 112 may include an aperture that adjusts the amount of input light.

The lens module 112 may further include a sensor for detecting the movement of the imaging device 100 or the electronic device, such as a shaking motion, etc. In an embodiment, the lens module 112 may further include a gyro sensor, and the gyro sensor may detect a movement of the imaging device 100 or the electronic device and transmit a detection result to the tilting module 120 or the processor 130. The processor 130 may control the tilting module 120 to correct a shake, based on the detection result.

The lens may be mounted on an optical axis of the image sensor 114, and the optical axis may be in the front or rear direction of the imaging device 100. The lens may receive light reflected by an object located within a viewing angle. The lens module 112 may include one lens or a plurality of lenses.

The image sensor 114 may convert light input through the lens module 112 into an electrical signal. For example, the image sensor 114 may generate an image by using object information in light input through the lens module 112. The image sensor 114 may transmit the generated image data to the processor 130.

The image sensor 114 may include a pixel array that receives an optical signal. The pixel array may include, for example, a photoelectric conversion device such as a charge coupled device (CCD) or a complementary metal oxide semiconductor (CMOS), and may include various types of photoelectric conversion devices. The pixel array may include a plurality of pixels that convert a received optical signal into an electrical signal, and the plurality of pixels may be arranged in a matrix. Each of the plurality of pixels includes a photo-sensing element. For example, the photo-sensing element may include a photodiode, a phototransistor, a photogate, a pinned photodiode, or the like.

The tilting module 120 may control an actuator driving module (not shown) to change the position or location of a lens of the lens module 112. The actuator driving module may change the position or location as well as the direction of the lens in the lens module 112 by driving an actuator. The tilting module 120 may control the actuator to change the location of the lens of the lens module 112, the location of the lens module 112, or the location of the camera module 110 including the lens module 112.

A target correction value for moving the lens may be calculated to correct noise caused by the movement of the imaging device 100 or the electronic device. The target correction value may be a value corresponding to a movement distance of the lens for shake correction (i.e., image stabilization) in a first direction or a second direction.

The tilting module 120 may be a shake correction module, i.e., an image stabilization module. The image stabilization module may perform hand shake correction of the imaging device 100 or the electronic device in order to prevent image shake due to a user's hand shake during image capture.

The processor 130 may control the overall operation of the imaging device 100. According to an embodiment, the processor 130 may control each of the lens module 112, the image sensor 114, and the tilting module 120 to perform correction when capturing an image according to various embodiments of the inventive concept.

For example, the image sensor 114 may receive light reflected by an object through the lens module 112 to generate image data IDT. The image sensor 114 may transmit the generated image data IDT to the processor 130. The processor 130 may recognize a target object based on the received image data IDT, and compare the location of the target object with reference location information including optimal object location information when capturing an image and generate tilting control data TCD. The processor 130 may transmit the generated tilting control data TCD to the tilting module 120. The tilting module 120 may move the lens, the lens module 112, or the camera module 110 according to the received tilting control data TCD to generate improved image data. The terms “tilt” and “tilting”, as used herein, mean any type of movement and/or position adjustment of a lens, lens module 112, and camera module 110.

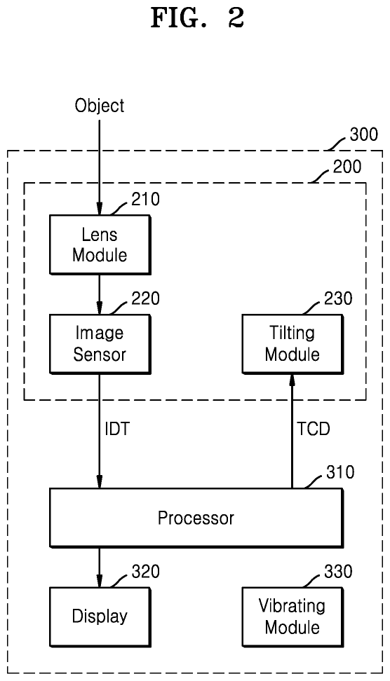

FIG. 2 is a block diagram of an imaging device according to an example embodiment of the inventive concept.

A camera module 200 according to an example embodiment of the inventive concept may be provided in an electronic device having an image capturing or light sensing function. For example, the camera module 200 may be provided in an electronic device such as a digital still camera, a digital video camera, a smartphone, a wearable device, an IoT device, a tablet PC, a PDA, a PMP, and a navigation device.

Referring to FIG. 2, the camera module 200 may include a lens module 210, an image sensor 220, and a tilting module 230. The lens module 210, the image sensor 220, and the tilting module 230 may be the lens module 112, the image sensor 114, and the tilting module 120 in the imaging device 100 of FIG. 1.

An electronic device 300 may include a processor 310, a display 320, a vibration module 330 configured to generate vibration, and the camera module 200.

The processor 310 may control the overall operation of the electronic device 300. According to an embodiment, the processor 310 may control the camera module 200 to perform correction when capturing an image according to various embodiments of the inventive concept.

The display 320 may display an image captured by the camera module 200 or an image stored in a memory. According to an embodiment, the display 320 may be located on a first surface of the electronic device 300, and the camera module 200 may be located on the first surface on which the display 320 is located, or may be located on a second surface opposite to the first surface on which the display 320 is located.

An interface circuit (not shown) may be included in the camera module 200 to receive image data IDT and transmit the image data IDT to the processor 310 according to a set protocol. The interface circuit may generate data by packing the image data IDT in individual signal units, packet units, or frame units according to a set protocol and transmit the data to the processor 310. For example, the interface circuit may include a mobile industry processor interface (MIPI).

For example, the image sensor 220 may receive an object through the lens module 210 to generate image data IDT. The image sensor 220 may transmit the generated image data IDT to the processor 310. The processor 310 may recognize a target object based on the received image data IDT, and compare the location of the target object with reference location information including optimal object location information when capturing an image and generate tilting control data TCD. The processor 310 may transmit the generated tilting control data TCD to the tilting module 230. The tilting module 230 may move (i.e., adjust a position of) the lens, the lens module 210, or the camera module 200 according to the received tilting control data TCD to generate improved image data. In addition, the processor 310 may control the tilting module 230 to generate a photographing guide signal including vibration through the vibration module 330 when the location of a target object in acquired image data is within a preset range.

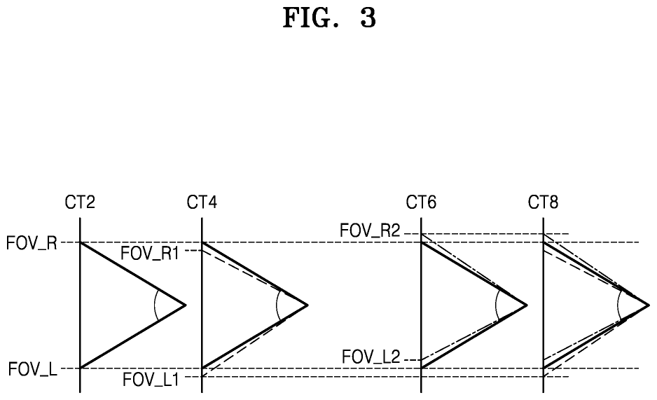

FIG. 3 is a diagram illustrating a field of view of an imaging device according to an example embodiment of the inventive concept.

Referring to FIG. 3, a basic field of view CT2 of the imaging device is from a right boundary FOV_R to a left boundary FOV_L, and when tilting to the left through a tilting module, a field of view CT4 is changed from a first right boundary FOV_R1 to a first left boundary FOV_L1. When tilting to the right through the tilting module, a field of view CT6 is changed from a second right boundary FOV_R2 to a second left boundary FOV_L2. A field of view CT8 that the imaging device may obtain through the tilting module is from the second right boundary FOV_R2 to the first left boundary FOV_L1, and may receive an image of a wider area than the basic field of view CT2 of the imaging device. The imaging device according to an example embodiment of the inventive concept may provide an improved selfie photograph result by using the field of view described with reference to FIG. 3.

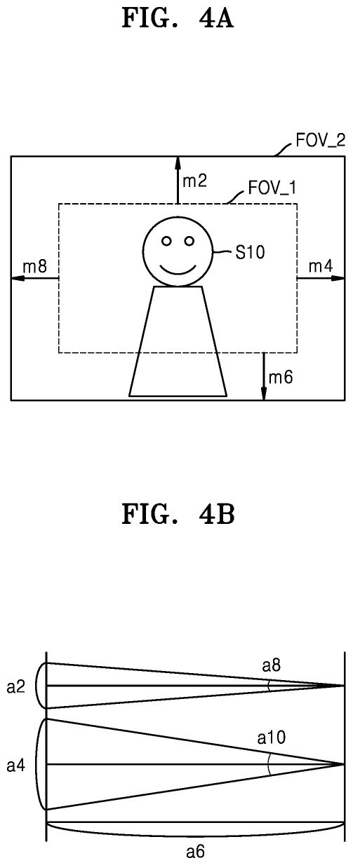

FIGS. 4A and 4B are diagrams illustrating a field of view of an imaging device according to an example embodiment of the inventive concept.

Referring to FIG. 4A, when a camera module is tilted up, down, left, and right through a tilting module in a first field of view FOV_1, which is a basic field of view of the imaging device, the field of view of the imaging device may be as wide as a second field of view FOV_2.

Referring to FIG. 4B, when the camera module is tilted by a first angle a8, the field of view of the imaging device may be a first field of view a2, and when the camera module is tilted by a second angle a10, the field of view of the imaging device may be a second field of view a4. When a tiltable range increases from the first angle a8 to the second angle a10, the field of view of the imaging device may increase in proportion thereto. Also, when a photographing distance a6 increases during photographing, the field of view of the imaging device may further increase.

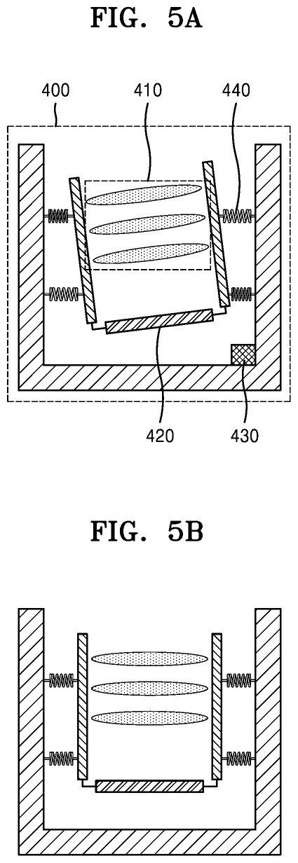

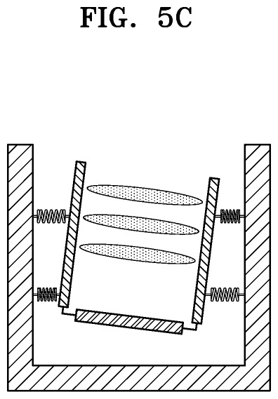

FIGS. 5A to 5C are diagrams illustrating a tilting operation of an imaging device 400 according to an example embodiment of the inventive concept.

Referring to FIG. 5A, the imaging device 400 may include a lens module 410, an image sensor 420, a controller 430, and a tilting module 440. The lens module 410 may include a plurality of lenses. For example, the tilting module 440 may tilt the lens module 410 and the image sensor 420 together. FIG. 5B is a diagram illustrating a basic location of the imaging device 400 before the tilting operation, FIG. 5A is a diagram illustrating controlling the tilting module 440 to tilt the imaging device 400 in a first direction, and FIG. 5C is a diagram illustrating controlling the tilting module 440 to tilt the imaging device 400 in a second direction opposite to the first direction.

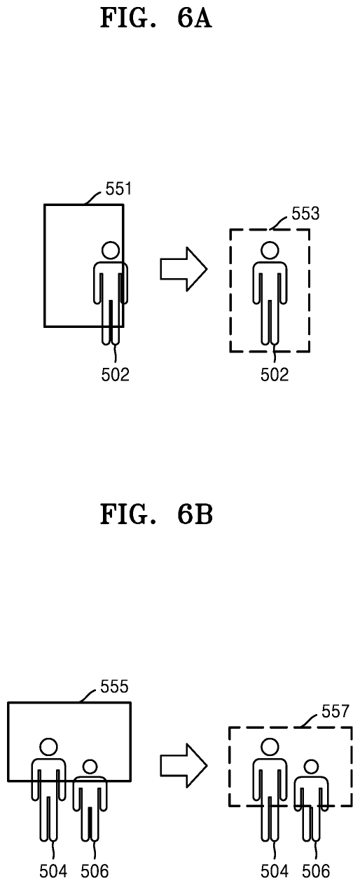

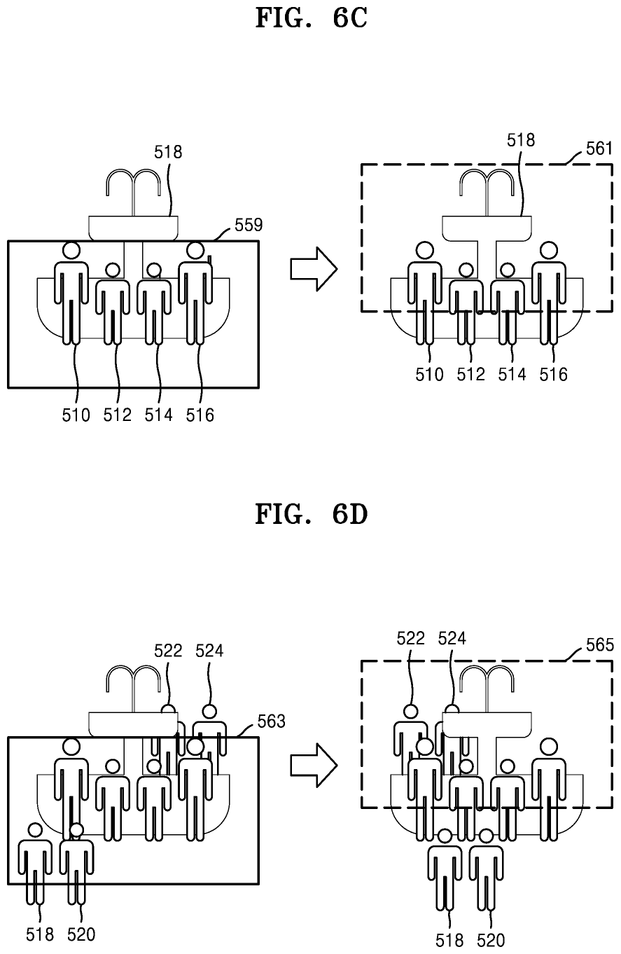

FIGS. 6A to 6D are diagrams illustrating a tilting algorithm of an imaging device according to an example embodiment of the inventive concept.

The imaging device recognizes the location of a target object in an output image generated through an image sensor, grasps information of a scene being photographed, and controls a tilting module. For example, referring to FIG. 6A, one person may be recognized as a first target object 502 in a first frame 551 initially photographed by the imaging device. Because a part of the first target object 502, which is recognized, does not appear at the lower right side of the first frame 551, the field of view of the imaging device may be changed to a first correction frame 553 by controlling the tilting module. In the first correction frame 553, the first target object 502 may be located at the center thereof.

Referring to FIG. 6B, two people may be recognized as second target objects 504 and 506 in a second frame 555 initially photographed by the imaging device. Because the second target objects 504 and 506, which are recognized, do not mostly appear at the bottom of the second frame 555 and only the face of one (e.g., the second target object 506) of the second target objects 504 and 506 is displayed, the field of view of the imaging device may be changed to a second correction frame 557 by controlling the tilting module. The second correction frame 555 may be located such that the upper bodies of the second target objects 504 and 506 completely appear on the screen.

Referring to FIG. 6C, four people and an object may be recognized as third target objects 510, 512, 514, 516, and 518 in a third frame 559 initially photographed by the imaging device. Because the third target objects 510, 512, 514, 516, and 518, which are recognized, are partially displayed in the third frame 559, the field of view of the imaging device may be changed to a third correction frame 561 by controlling the tilting module. The third correction frame 561 may be located such that the upper bodies of the four people among the third target objects 510, 512, 514, 516, and 518 are displayed and the object 518 is also displayed without cutting the upper part thereof.

Referring to FIG. 6D, people and objects may be recognized as fourth target objects in a fourth frame 563 initially photographed by the imaging device. Because the recognized fourth target objects are partially displayed in the fourth frame 563, the field of view of the imaging device may be changed to a fourth correction frame 565 by controlling the tilting module. The fourth correction frame 565 may be located to display persons and objects, which are photographing targets among the fourth target objects. For example, first non-target objects 522 and 524 may be excluded from the photographing targets by determining whether there is significant movement during photographing or determining whether their gazes are toward the camera through facial recognition. Second non-target objects 518 and 520 may be excluded from the photographing targets due to significant movement or motion thereof during photographing.

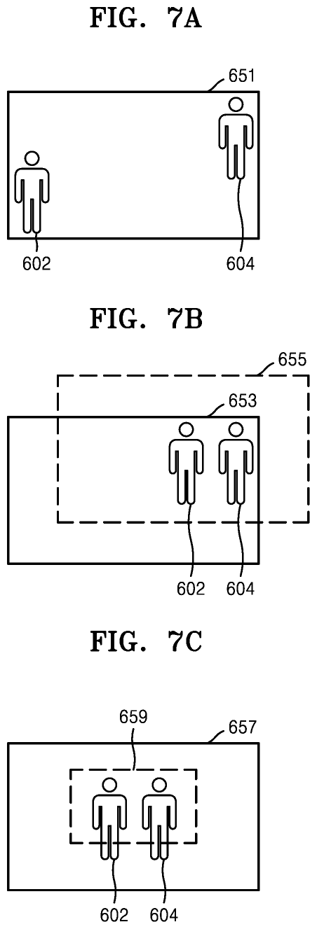

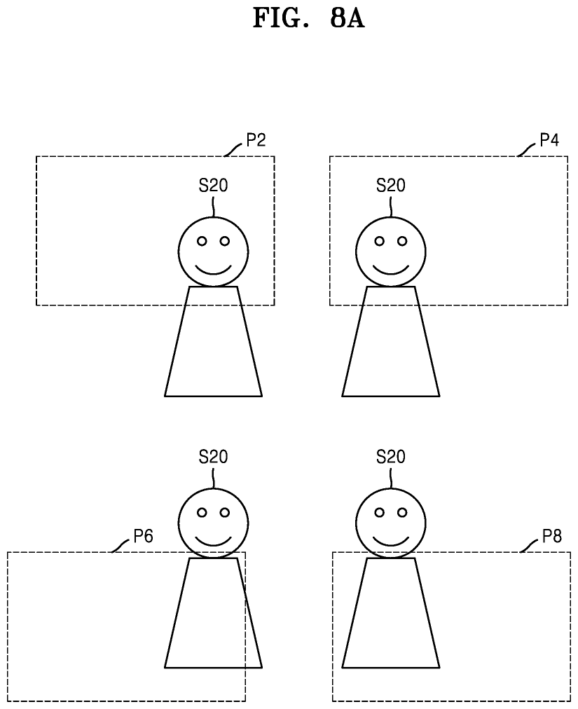

FIGS. 7A to 7C are diagrams illustrating a tilting algorithm of an imaging device according to an example embodiment of the inventive concept.

The imaging device may capture an improved image by combining a tilting operation with a zoom function in the imaging device. For example, in FIG. 7A, a first target person 602 and a second target person 604 may be recognized in a fifth frame 651 that is a photographing field of view. Referring to FIG. 7B, when the first target person 602 and the second target person 604 move to locations close to each other, the imaging device may control the tilting module to locate the first target person 602 and the second target person 604 in the center of the photographing field of view. The photographing field of view may be changed from a sixth frame 653 to a seventh frame 655. Referring to FIG. 7C, the first target person 602 and the second target person 604 are in the center of an eighth frame 657, but the ratio of the first target person 602 to the second target person 604 in a captured image is less than a target ratio, and thus, the imaging device may perform a zoom-in operation. The imaging device may adjust the ratio of the first target person 602 to the second target person 604 in the captured image to be close to the target ratio by changing the photographing field of view from the eighth frame 657 to a ninth frame 659 through a zoom-in operation.

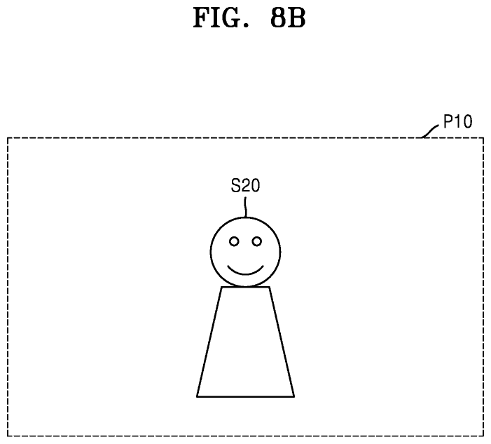

FIGS. 8A and 8B are diagrams illustrating panoramic photographing by an imaging device according to an example embodiment of the inventive concept.

The imaging device may perform panoramic photographing through continuous photographing and synthesizing. For example, referring to FIG. 8A, the imaging device may recognize a panoramic target object S20. The imaging device may set a first panoramic frame P2, a second panoramic frame P4, a third panoramic frame P6, and a fourth panoramic frame P8 with respect to the recognized panoramic target object S20, and may capture a plurality of pieces of image data corresponding to the first panoramic frame P2, the second panoramic frame P4, the third panoramic frame P6, and the fourth panoramic frame P8 by controlling the tilting module in stages.

Referring to FIG. 8B, the imaging device may generate a composite frame P10 by synthesizing the first panoramic frame P2, the second panoramic frame P4, the third panoramic frame P6, and the fourth panoramic frame P8. In the composite frame P10, the panoramic target object S20 may be in the center thereof. A selfie may be taken with a wider field of view than before through panoramic photography.

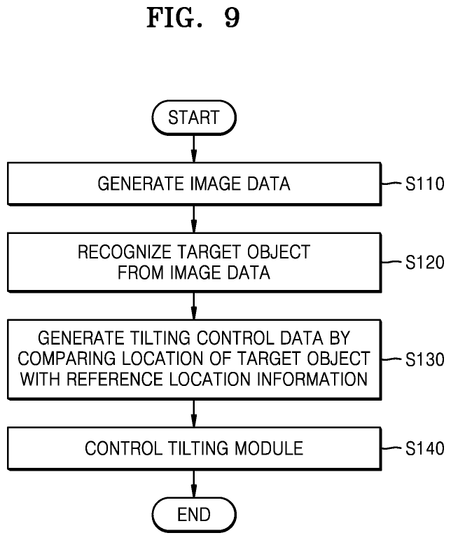

FIG. 9 is a flowchart illustrating an operation of an imaging device according to an example embodiment of the inventive concept.

The imaging device may generate image data by processing a received optical signal by an image sensor (operation S110).

The imaging device may recognize a target object from the generated image data (operation S120). The imaging device may recognize the target object based on a user's face information. For example, the imaging device may determine whether there is the target object by considering a direction of the gaze from the face of a person in the image data, and may determine whether there is the target object by considering the movement or amount of movement of a person in the image data. The imaging device may recognize the target object based on the location of an object in the image data or the type of information of the object. For example, when an object in the image data is a person and is close to the center thereof, the imaging device may determine the object as the target object.

The imaging device may generate tilting control data by comparing the location of the target object with reference location information including optimal object location information when capturing an image (operation S130).

The imaging device may control the tilting module based on the generated tilting control data (operation S140). The tilting module may be an optical image stabilization (OIS) module for compensating for shaking of the imaging device.

The imaging device may perform an operation of correcting distortion of image data generated while controlling the tilting module.

The imaging device may capture a plurality of pieces of image data by controlling the tilting module in stages based on the reference location information and the location of the target object, and may generate panoramic image data.

The imaging device may perform a zoom-in or zoom-out function such that the target object has a target ratio in the image data.

The imaging device may generate a photographing guide signal including vibration when the location of the target object in the image data is within a threshold range.

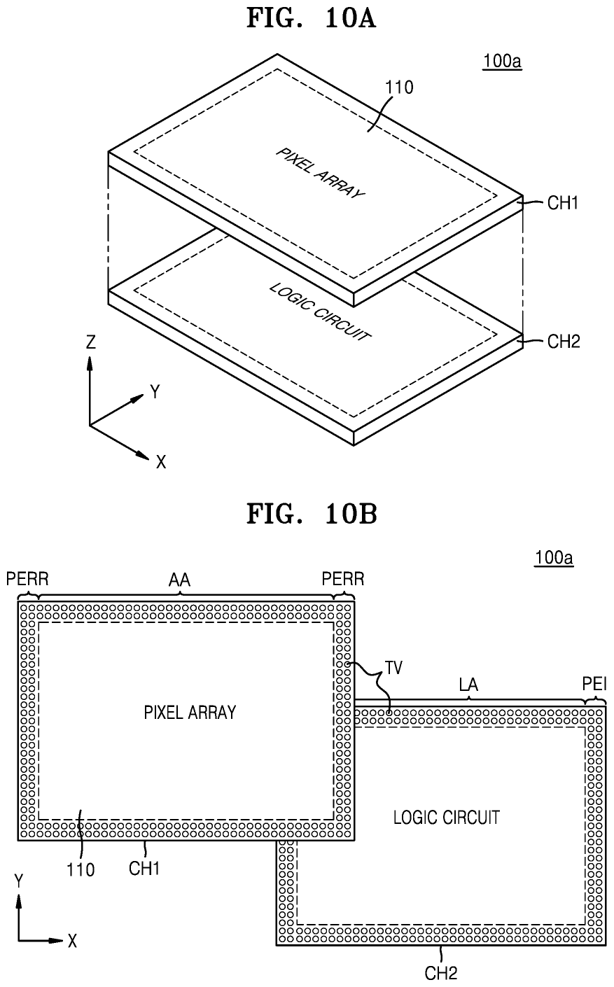

FIG. 10A is an exploded perspective view of an image sensor 100a according to an example embodiment, and FIG. 10B is a plan view of the image sensor 100a.

Referring to FIGS. 10A and 10B, the image sensor 100a may have a structure in which a first chip CH1 and a second chip CH2 are stacked. A pixel array (e.g., a pixel array of the camera module 110 in FIG. 1) may be formed in the first chip CH1, and logic circuits, such as a row driver 120, a readout circuit 130, and a ramp signal generator 140, and a timing controller 150, may be formed in the second chip CH2.

As illustrated in FIG. 10B, the first chip CH1 and the second chip CH2 may include an active area AA and a logic area LA arranged in the center of the first chip CH1 and the center of the second chip CH2, respectively, and may further include a peripheral area PERR and a peripheral area PEI arranged around the edge of the first chip CH1 and the edge of the second chip CH2, respectively. In the active area AA of the first chip CH1, a plurality of pixels may be arranged in a two-dimensional array structure. A logic circuit may be arranged in the logic area LA of the second chip CH2.

Through vias extending in a third direction (a Z direction) may be arranged in the peripheral area PERR of the first chip CH1 and the peripheral area PEI of the second chip CH2. The first chip CH1 and the second chip CH1 may be electrically coupled to each other through the through vias. Wiring lines and vertical contacts extending in a first direction (an X direction) or a second direction (a Y direction) may be further formed in the peripheral area PERR of the first chip CH1.

A plurality of wiring lines extending in the first direction (the X direction) and the second direction (the Y direction) may also be arranged in a wiring layer of the second chip CH2, and the wiring lines may be connected to the logic circuit.

Although a structure in which the first chip CH1 and the second chip CH2 are electrically coupled to each other through the through vias has been described, the inventive concept is not limited thereto. For example, the first chip CH1 and the second chip CH2 may be implemented to have various coupling structures such as copper (Cu)—Cu bonding, coupling of a through via and a Cu pad, coupling of a through via and an external connection terminal, and coupling through an integral through via.

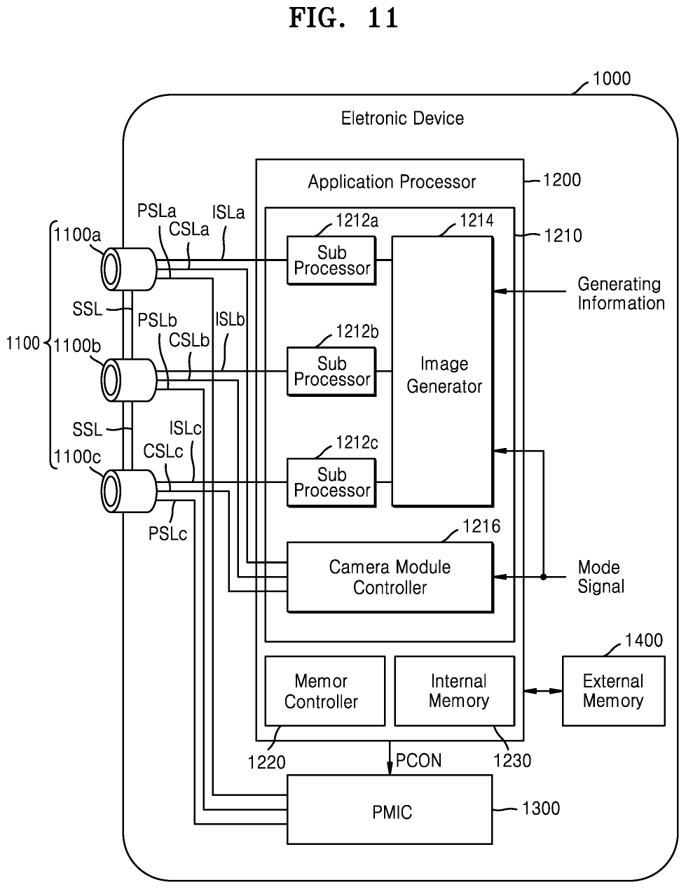

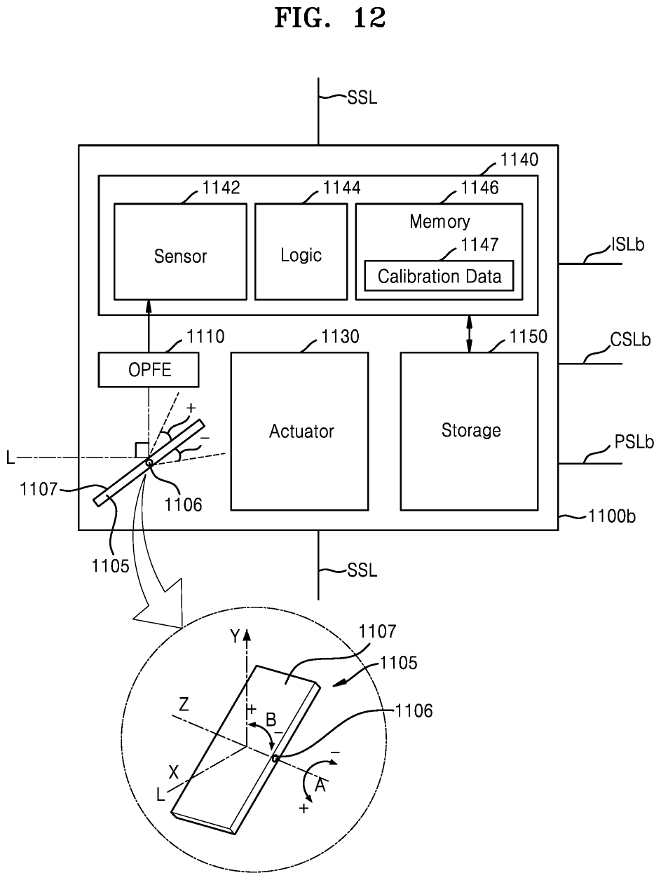

FIG. 11 is a block diagram of an electronic device 1000 including a multi-camera module, according to an example embodiment. FIG. 12 is a detailed block diagram of a camera module in the electronic device 1000 of FIG. 11.

Referring to FIG. 11, the electronic device 1000 may include a camera module group 1100, an application processor 1200, a power management integrated circuit (PMIC) 1300, and an external memory 1400.

The camera module group 1100 may include a plurality of camera modules 1100a, 1100b, and 1100c. Although three camera modules 1100a, 1100b, and 1100c are illustrated in FIG. 11, the inventive concept is not limited thereto. In some embodiments, the camera module group 1100 may be modified to include only two camera modules. In some embodiments, the camera module group 1100 may be modified to include “k” camera modules, where “k” is a natural number of 4 or more.

The detailed configuration of the camera module 1100b will be described with reference to FIG. 12 below. The descriptions below may also be applied to the other camera modules 1100a and 1100c.

Referring to FIG. 12, the camera module 1100b may include a prism 1105, an optical path folding element (OPFE) 1110, an actuator 1130, an image sensing device 1140, and a storage 1150.

The prism 1105 may include a reflective surface 1107 of a light reflecting material and may change the path of light L incident from outside.

In some embodiments, the prism 1105 may change the path of the light L incident in a first direction (an X direction) into a second direction (a Y direction) perpendicular to the first direction (the X direction). The prism 1105 may rotate the reflective surface 1107 of the light reflecting material in a direction A around a central shaft 1106 or rotate the central shaft 1106 in a direction B to change the path of the light L incident in the first direction (the X direction) into the second direction (the Y direction) perpendicular to the first direction (the X direction). In this case, the OPFE 1110 may move in a third direction (a Z direction), which is perpendicular to the first direction (the X direction) and the second direction (the Y direction).

In some embodiments, as illustrated in FIG. 12, an A-direction maximum rotation angle of the prism 1105 may be less than or equal to 15 degrees in a plus (+) A direction and greater than 15 degrees in a minus (−) A direction. However, the inventive concept is not limited thereto.

In some embodiment, the prism 1105 may move by an angle of about 20 degrees or in a range from about 10 degrees to about 20 degrees or from about 15 degrees to about 20 degrees in a plus or minus B direction. In this case, an angle by which the prism 1105 moves in the plus B direction may be the same as or similar, within a difference of about 1 degree, to an angle by which the prism 1105 moves in the minus B direction.

In some embodiments, the prism 1105 may move the reflective surface 1107 of the light reflecting material in the third direction (the Z direction) parallel with an extension direction of the central shaft 1106.

The OPFE 1110 may include, for example, “m” optical lenses, where “m” is a natural number. The “m” lenses may move in the second direction (the Y direction) and change an optical zoom ratio of the camera module 1100b. For example, when the default optical zoom ratio of the camera module 1100b is Z, the optical zoom ratio of the camera module 1100b may be changed to 3Z, 5Z, or greater by moving the “m” optical lenses included in the OPFE 1110.

The actuator 1130 may move the OPFE 1110 or an optical lens to a certain location. For example, the actuator 1130 may adjust the location of the optical lens such that an image sensor 1142 is located at a focal length of the optical lens for accurate sensing.

The image sensing device 1140 may include the image sensor 1142, a control logic 1144, and a memory 1146. The image sensor 1142 may sense an image of an object using the light L provided through the optical lens. The image sensor 1142 may generate image data having a high motion range by merging high conversion gain HCG image data with low conversion gain LCG image data.

The control logic 1144 may control all operations of the camera module 1100b. For example, the control logic 1144 may control operation of the camera module 1100b according to a control signal provided through a control signal line CSLb.

The memory 1146 may store information, such as calibration data 1147, necessary for the operation of the camera module 1100b. The calibration data 1147 may include information, which is necessary for the camera module 1100b to generate image data using the light L provided from outside. For example, the calibration data 1147 may include information about the degree of rotation, information about a focal length, information about an optical axis, or the like. When the camera module 1100b is implemented as a multi-state camera that has a focal length varying with the location of the optical lens, the calibration data 1147 may include a value of a focal length for each location (or state) of the optical lens and information about auto focusing.

The storage 1150 may store image data sensed by the image sensor 1142. The storage 1150 may be provided outside the image sensing device 1140 and may form a stack with a sensor chip of the image sensing device 1140. In some embodiments, although the storage 1150 may include electrically erasable programmable read-only memory (EEPROM), the inventive concept is not limited thereto.

Referring to FIGS. 11 and 12, in some embodiments, each of the camera modules 1100a, 1100b, and 1100c may include the actuator 1130. Accordingly, the camera modules 1100a, 1100b, and 1100c may include the calibration data 1147, which is the same or different among the camera modules 1100a, 1100b, and 1100c according to the operation of the actuator 1130 included in each of the camera modules 1100a, 1100b, and 1100c.

In some embodiments, one (e.g., the camera module 1100b) of the camera modules 1100a, 1100b, and 1100c may be of a folded-lens type including the prism 1105 and the OPFE 1110 while the other camera modules (e.g., the camera modules 1100a and 1100c) may be of a vertical type that does not include the prism 1105 and the OPFE 1110. However, the inventive concept is not limited thereto.

In some embodiments, one (e.g., the camera module 1100c) of the camera modules 1100a, 1100b, and 1100c may include a vertical depth camera, which extracts depth information using an infrared ray (IR). In this case, the application processor 1200 may generate a three-dimensional (3D) depth image by merging image data provided from the depth camera with image data provided from another camera module (e.g., the camera module 1100a or 1100b).

In some embodiments, at least two camera modules (e.g., the camera modules 1100a and 1100b) among the camera modules 1100a, 1100b, and 1100c may have different field-of-views. In this case, for example, the two camera modules (e.g., the camera modules 1100a and 1100b) among the camera modules 1100a, 1100b, and 1100c may respectively have different optical lenses. However, the inventive concept is not limited thereto.

In some embodiments, the camera modules 1100a, 1100b, and 1100c may have different field-of-views from one another. In this case, although the camera modules 1100a, 1100b, and 1100c may respectively have different optical lenses, the inventive concept is not limited thereto.

In some embodiments, the camera modules 1100a, 1100b, and 1100c may be physically separated from one another. In other words, the sensing area of the image sensor 1142 is not divided and used by the camera modules 1100a, 1100b, and 1100c, but the image sensor 1142 may be independently included in each of the camera modules 1100a, 1100b, and 1100c.

Referring back to FIG. 11, the application processor 1200 may include an image processing unit 1210, a memory controller 1220, and an internal memory 1230. The application processor 1200 may be separately implemented from the camera modules 1100a, 1100b, and 1100c. For example, the application processor 1200 and the camera modules 1100a, 1100b, and 1100c may be implemented in different semiconductor chips.

The image processing unit 1210 may include a plurality of sub-image processors 1212a, 1212b, and 1212c, an image generator 1214, and a camera module controller 1216.

The image processing unit 1210 may include as many sub-image processors 1212a, 1212b, and 1212c as the camera modules 1100a, 1100b, and 1100c.

Pieces of image data respectively generated by the camera modules 1100a, 1100b, and 1100c may be respectively provided to the sub-image processors 1212a, 1212b, and 1212c through image signal lines ISLa, ISLb, and ISLc separated from each other. For example, image data generated by the camera module 1100a may be provided to the sub-image processor 1212a through the image signal line ISLa, image data generated by the camera module 1100b may be provided to the sub-image processor 1212b through the image signal line ISLb, and image data generated by the camera module 1100c may be provided to the sub-image processor 1212c through the image signal line ISLc. Such image data transmission may be performed using, for example, a MIPI-based camera serial interface (CSI). However, the inventive concept is not limited thereto.

In some embodiments, a single sub-image processor may be provided for a plurality of camera modules. For example, differently from FIG. 13, the sub-image processors 1212a and 1212c may not be separated but may be integrated into a single sub-image processor, and the image data provided from the camera module 1100a or the camera module 1100c may be selected by a selection element (e.g., a multiplexer) and then provided to the integrated sub-image processor.

The image data provided to each of the sub-image processors 1212a, 1212b, and 1212c may be provided to the image generator 1214. The image generator 1214 may generate an output image using the image data provided from each of the sub-image processors 1212a, 1212b, and 1212c according to image generation information or a mode signal.

In detail, the image generator 1214 may generate the output image by merging at least portions of respective pieces of image data, which are respectively generated by the camera modules 1100a, 1100b, and 1100c having different field-of-views, according to the image generation information or the mode signal. Alternatively, the image generator 1214 may generate the output image by selecting one of pieces of image data, which are respectively generated by the camera modules 1100a, 1100b, and 1100c having different field-of-views, according to the image generation information or the mode signal.

In some embodiments, the image generation information may include a zoom signal or a zoom factor. In some embodiments, the mode signal may be based on a mode selected by a user.

When the image generation information includes a zoom signal or a zoom factor and the camera modules 1100a, 1100b, and 1100c have different field-of-views, the image generator 1214 may perform different operations according to different kinds of zoom signals. For example, when the zoom signal is a first signal, the image generator 1214 may merge image data output from the camera module 1100a with image data output from the camera module 1100c and then generate an output image by using a merged image signal and image data output from the camera module 1100b and not used for merging. When the zoom signal is a second signal different from the first signal, the image generator 1214 may generate an output image by selecting one of the pieces of image data respectively output from the camera modules 1100a, 1100b, and 1100c, instead of performing the merging. However, the inventive concept is not limited thereto, and a method of processing image data may be changed whenever necessary.

In some embodiments, the image generator 1214 may receive a plurality of pieces of image data, which have different exposure times, from at least one of the sub-image processors 1212a, 1212b, and 1212c and perform high dynamic range (HDR) processing on the pieces of image data, thereby generating merged image data having an increased dynamic range.

The camera module controller 1216 may provide a control signal to each of the camera modules 1100a, 1100b, and 1100c. A control signal generated by the camera module controller 1216 may be provided to a corresponding one of the camera modules 1100a, 1100b, and 1100c through a corresponding one of control signal lines CSLa, CSLb, and CSLc, which are separated from one another.

One (e.g., the camera module 1100b) of the camera modules 1100a, 1100b, and 1100c may be designated as a master camera according to the mode signal or the image generation signal including a zoom signal, and the other camera modules (e.g., the camera modules 1100a and 1100c) may be designated as slave cameras. Such designation information may be included in a control signal and provided to each of the camera modules 1100a, 1100b, and 1100c through a corresponding one of the control signal lines CSLa, CSLb, and CSLc, which are separated from one another.

A camera module operating as a master or a slave may be changed according to a zoom factor or an operation mode signal. For example, when the field-of-view of the camera module 1100a is greater than that of the camera module 1100b and the zoom factor indicates a low zoom ratio, the camera module 1100a may operate as a master and the camera module 1100b may operate as a slave. Contrarily, when the zoom factor indicates a high zoom ratio, the camera module 1100b may operate as a master and the camera module 1100a may operate as a slave.

In some embodiments, a control signal provided from the camera module controller 1216 to each of the camera modules 1100a, 1100b, and 1100c may include a sync enable signal. For example, when the camera module 1100b is a master camera and the camera module 1100a is a slave camera, the camera module controller 1216 may transmit the sync enable signal to the camera module 1100b. The camera module 1100b provided with the sync enable signal may generate a sync signal based on the sync enable signal and may provide the sync signal to the camera modules 1100a and 1100c through a sync signal line SSL. The camera modules 1100a, 1100b, and 1100c may be synchronized with the sync signal and may transmit image data to the application processor 1200.

In some embodiments, a control signal provided from the camera module controller 1216 to each of the camera modules 1100a, 1100b, and 1100c may include mode information according to the mode signal. The camera modules 1100a, 1100b, and 1100c may operate in a first operation mode or a second operation mode in relation with a sensing speed based on the mode information.

In the first operation mode, the camera modules 1100a, 1100b, and 1100c may generate an image signal at a first speed (e.g., at a first frame rate), encode the image signal at a second speed higher than the first speed (e.g., at a second frame rate higher than the first frame rate), and transmit an encoded image signal to the application processor 1200. In this case, the second speed may be 30 times or less the first speed.

The application processor 1200 may store the received image signal, i.e., the encoded image signal, in the internal memory 1230 therein or an external memory 1400 outside the application processor 1200. Thereafter, the application processor 1200 may read the encoded image signal from the internal memory 1230 or the external memory 1400, decode the encoded image signal, and display image data generated based on a decoded image signal. For example, a corresponding one of the sub-image processors 1212a, 1212b, and 1212c of the image processing unit 1210 may perform the decoding and may also perform image processing on the decoded image signal.

In the second operation mode, the camera modules 1100a, 1100b, and 1100c may generate an image signal at a third speed lower than the first speed (e.g., at a third frame rate lower than the first frame rate) and transmit the image signal to the application processor 1200. The image signal provided to the application processor 1200 may not have been encoded. The application processor 1200 may perform image processing on the image signal or store the image signal in the internal memory 1230 or the external memory 1400.

The PMIC 1300 may provide power, e.g., a power supply voltage, to each of the camera modules 1100a, 1100b, and 1100c. For example, under the control of the application processor 1200, the PMIC 1300 may provide first power to the camera module 1100a through a power signal line PSLa, second power to the camera module 1100b through a power signal line PSLb, and third power to the camera module 1100c through a power signal line PSLc.

The PMIC 1300 may generate power corresponding to each of the camera modules 1100a, 1100b, and 1100c and adjust the level of the power, in response to a power control signal PCON from the application processor 1200. The power control signal PCON may include a power adjustment signal for each operation mode of the camera modules 1100a, 1100b, and 1100c. For example, the operation mode may include a low-power mode. In this case, the power control signal PCON may include information about a camera module to operate in the low-power mode and a power level to be set. The same or different levels of power may be respectively provided to the camera modules 1100a, 1100b, and 1100c. The level of power may be dynamically changed.

While the inventive concept has been particularly shown and described with reference to embodiments thereof, it will be understood that various changes in form and details may be made therein without departing from the scope of the following claims.

What is claimed is:

1. An imaging device comprising:
a lens module configured to receive an optical signal;
an image sensor configured to generate image data based on the received optical signal;
a tilting module configured to adjust a position of the image sensor; and
a processor configured to control the tilting module based on the image data,
wherein the processor is further configured to recognize a target object from the image data and control the tilting module in response to comparing a location of the target object with reference location information including object location information.

2. The imaging device of claim 1, wherein the tilting module is further configured to adjust a position of the lens module and adjust the position of the image sensor in response to detecting movement of the imaging device.

3. The imaging device of claim 1, wherein the processor is further configured to correct distortion of the image data generated as optical axes of the lens module and the image sensor are changed.

4. The imaging device of claim 1, wherein the processor is further configured to recognize the target object based on user face information, wherein the user face information comprises a direction of a gaze of the user.

5. The imaging device of claim 1, wherein the processor is further configured to recognize the target object based on at least one of a location of an object and information on a type of the object, included in the image data.

6. The imaging device of claim 1, wherein the processor is further configured to generate panoramic image data from pieces of image data obtained by stepwise controlling the tilting module.

7. The imaging device of claim 1, wherein the processor is further configured to perform a zoom-in or zoom-out function by controlling the lens module so that the target object has a target ratio on a screen corresponding to the image data.

8. The imaging device of claim 1, wherein the processor is further configured to enable or disable a control mode of the tilting module when the imaging device is used to take a selfie photograph.

9. The imaging device of claim 1, wherein the processor is configured to generate a photographing guide signal when the target object is in a certain area on a screen corresponding to the image data.

10. An electronic device comprising:
a camera module configured to provide a selfie photograph assistance function; and
a processor;
wherein the camera module comprises:
a lens module configured to receive an optical signal;
an image sensor configured to generate image data based on the received optical signal;
a tilting module configured to adjust a position of the camera module; and
an interface circuit configured to communicate with the processor, transmit the image data to the processor, and receive tilting control data for controlling the tilting module from the processor, and
wherein the processor is configured to recognize a target object from the image data, compare a location of the target object with reference location information including object location information when capturing an image and generate the tilting control data, and transmit the tilting control data to the tilting module through the interface circuit.

11. The electronic device of claim 10, wherein the tilting module is further configured to adjust a position of both the lens module and the image sensor in response to detecting movement of the camera module.

12. The electronic device of claim 10, wherein the processor is further configured to correct distortion of the image data generated as optical axes of the lens module and the image sensor are changed.

13. The electronic device of claim 10, wherein the processor is further configured to recognize the target object based on user face information.

14. The electronic device of claim 10, wherein the processor is further configured to recognize the target object based on at least one of a location of an object and information on a type of the object, included in the image data.

15. The electronic device of claim 10, wherein the processor is further configured to stepwise control the tilting module based on the reference location information and the location of the target object to capture pieces of image data, and generate panoramic image data.

16. The electronic device of claim 10, wherein the processor is further configured to perform a zoom-in or zoom-out function by controlling the lens module so that the target object has a target ratio on a screen corresponding to the image data.

17. The electronic device of claim 10, wherein the processor is configured to generate a photographing guide signal when the target object is in a certain area on a screen corresponding to the image data.

18. The electronic device of claim 10, wherein the electronic device comprises a plurality of camera modules,
wherein at least one of the plurality of camera modules provides the selfie photograph assistance function.

19. The electronic device of claim 10, wherein the electronic device comprises a display device on a first surface of the electronic device, and the camera module is arranged on a second surface opposite to the first surface.

20. A method of controlling a camera module supporting selfie photograph assistance, the method comprising:
generating image data based on an optical signal received through the camera module, recognizing a target object based on the generated image data, and generating target object information;
comparing the target object information with reference location information including object location information when capturing an image; and
controlling a field of view for photographing by tilting the camera module based on a result of the comparing.
